(19) United States
(12) Patent Application Publication
(10) Pub. No.: US 2007/0208750 A1
(43) Pub. Date: Sep. 6, 2007

(54) Method and system for access to distributed data

(75) Inventors: Boaz Carmeli, Koranit (IL); James H. Kaufman, San Jose, CA (US)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/365,735

(22) Filed: Mar. 1, 2006

(51) Int. Cl. G06F 17/30

(52) U.S. Cl. 707/10

(57) ABSTRACT

A method and system are provided for access to distributed data. The system includes a first entity (201-203) storing client data (221-223), the first entity (201-203) requiring access information (220) to access the client data (221-223). A storage device (200), held by the client, provides the access information (220) to access the client data (221-223). A second entity (204) is capable of accessing the stored client data (221-223) from the first entity (201-203) when provided with the access information (220) from the client. A plurality of first entities (201-203) may store client data (221-223) for a single client and the storage device (200) may include a list of the locations and access information (220) for all the first entities (201-203). The storage device (200) may be, for example, a smart card or USB key.

### FIELD OF THE INVENTION

This invention relates to the field of access to distributed data. In particular, the invention relates to sharing data and information geographically.

### BACKGROUND OF THE INVENTION

Data in the form of information or records relating to an entity, for example a person or an organization, may be held in geographically distributed locations. An example context is medical information relating to a person and this context is used to describe the background art as it illustrates the problems encountered. However, other forms of data or records also have the same problems of being shared geographically and the problems described should not be considered to be limited to the medical information context. Other example contexts in which it is desired for data or records to be shared geographically include financial and banking, retail and manufacturing, telephony, education, police, court and prison, insurance, and automobile. This list is not exhaustive and many other contexts and forms of data or records may be envisaged. The data may be sensitive data (for example, such as data relating to medical, financial, education, police, prison, etc.).

Current state of the art solutions for cross enterprise medical content sharing suggest the use of regional registries to maintain information about patients and their related medical information. A patient is usually treated by a set of care providers in the patient's home region. The information held in such regional registries does not include the sensitive information itself, but references the care providers who hold the sensitive information.

As mobility increases, and medical treatment become more specialized, patients require medical treatment away from their home region. For these cases it is understandable that remote access to patient information is increasingly required. Enabling regional registries to communicate and exchange patient's medical information is required in medical IT systems for supporting sharing of medical content.

An option that may be considered for allowing a care provider to find all information related to a given patient across multiple registries, is to execute a distributed query over all available registries. However, this solution does not scale and is time and processor intensive.

Any centralising of records or metadata relating to records would be cumbersome and would have a privacy risk by having a large amount of patient related information in a publicly accessible place.

### SUMMARY OF THE INVENTION

According to a first aspect of the present invention there is provided a method for access to distributed data, comprising: storing client data with a first entity, the first entity requiring access information to access the client data; a client providing the access information to a second entity; and the second entity accessing the stored client data from the first entity.

The method may include storing data for a single client with a plurality of first entities.

The client may provide the access information in the form of location and access information for each first entity. Alternatively, the client may provide the access information by providing location and access information to a register of the first entities and their access information. In the latter case, the register may be updated by synchronising with the client or during on-line access by a second entity.

The access information may be credential and authorisation information specific to the client. The access information may be held by the client or a reference to the access information may be held by the client. The location information may be an Internet Protocol address or a Uniform Resource Locator.

The first entity may store the client data in a database accessed via the first entity. New client data generated by a second entity may be stored by the second entity, the second entity requiring access information to access the new client data.

According to a second aspect of the present invention there is provided a system for access to distributed data, comprising: a first entity storing client data, the first entity requiring access information to access the client data; a storage device held by the client providing the access information; and a second entity capable of accessing the stored client data from the first entity when provided with the access information from the client.

A plurality of first entities may store client data for a single client. The storage device may provide the access information in the form of location and access information for each first entity. Alternatively, the storage device may provide the access information by providing location and access information to a register of the first entities and their access information. The register may be updated by synchronising with the client storage device or during on-line access by a second entity.

The storage device may be a portable storage device which, in use, is coupled to a second entity. Alternatively, the storage device may be provided on a client's computer system and access information is provided to a second entity via a network communication.

According to a third aspect of the present invention there is provided a computer program product stored on a computer readable storage medium for access to distributed data, comprising computer readable program code means for performing the steps of: storing client data with a first entity, the first entity requiring access information to access the client data; a client providing the access information to a second entity; and the second entity accessing the stored client data from the first entity.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a schematic diagram of an arrangement of entities in which the present invention may be implemented;

FIG. 2 is a block diagram of a distributed computer system arrangement in accordance with the present invention;

FIG. 3 is a block diagram of a computer system in accordance with the present invention; and

FIGS. 4A and 4B are sequence diagrams of method in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The described method and system can be relevant within any domain in which three entity types exist:
1. Entity A—Organization A
2. Entity B—Organization B
3. Entity C—Client

The client has data that is stored with one or more of the organisations. The client may be any entity including an individual, an organisation, a product, etc. The data may be any form of data, records or information. In one embodiment, the data may be sensitive or confidential. For example, records relating to contexts such as medical, financial, police, court, prison, education, etc. In another embodiment, the data may non-confidential and available to the public but distributed across a plurality of organisations.

A transaction is carried out with the following sequence:
1. Client data is stored with entity B;
2. Entity B provides the client with access information with which she can access the stored data at entity B;
3. The client visits entity A and, in order for entity A to handle the client request, it needs access to the client data stored with entity B;
4. Entity A asks the client to provide details of entity B and the access information;
5. Entity A uses the information provided by the client to access the stored client data from entity B and to make use of it.

In the above scenario, entity B may store the client data elsewhere but access is only available via entity B using the access information held by the client. There may be multiple instances of entity B each storing data relating to the client and the client may have different access information for the different instances of entity B

The access information may be based on credentials of the client or security authorisation data, if the data is sensitive or confidential.

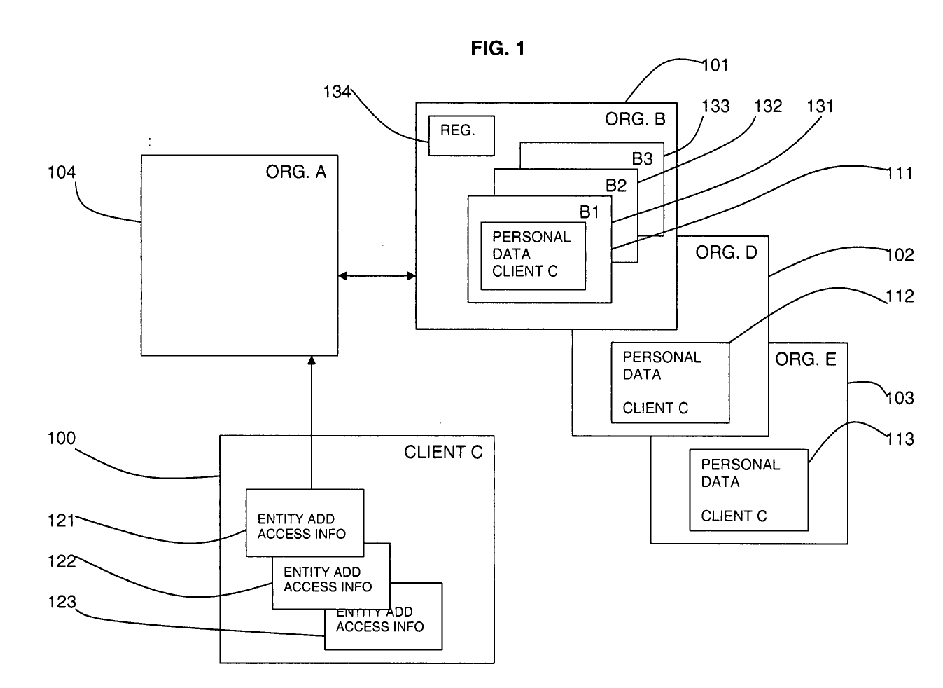

Referring to FIG. 1, a diagram illustrates the above scenario. A client C 100 has data records 111, 112, 113 stored with organizations B 101, D 102 and E 103. The data records 111-113 stored with each of the organizations 101-103 may be different.

An organization, for example organization B 101, may have entities B1 131, B2 132, B3 133 within the umbrella of the organization B 101, each entity may store data records 111. The organization B 101 may have a registry 134 storing information relating to the data records 111 within the organization B 101. For example, the organization B 101 may be a regional umbrella organization for entities within a geographic region.

In one embodiment, each of the data records 111-113 has access information 121, 122, 123 which is held by the client C 100. The access information may include an address of the entity holding the data record, credential and authorization information.

In another embodiment, the client C 100 only has access to the umbrella organization B 101 and not to the specific data records 111. After accessing organization B 101, the records are provided by organization B 101 to the client C 100. This is done by the fact that organization B 101 maintains a registry 134 or index for all the data records relating to client C 100.

If organization A 104 requires information from one or more of the data records 111-113 stored in the organizations B, D, E 101-103, it requests the access information 121-123 from the client C 100 enabling organization A 104 to obtain the data records 111-113 directly from the organizations B, D, E 101-103.

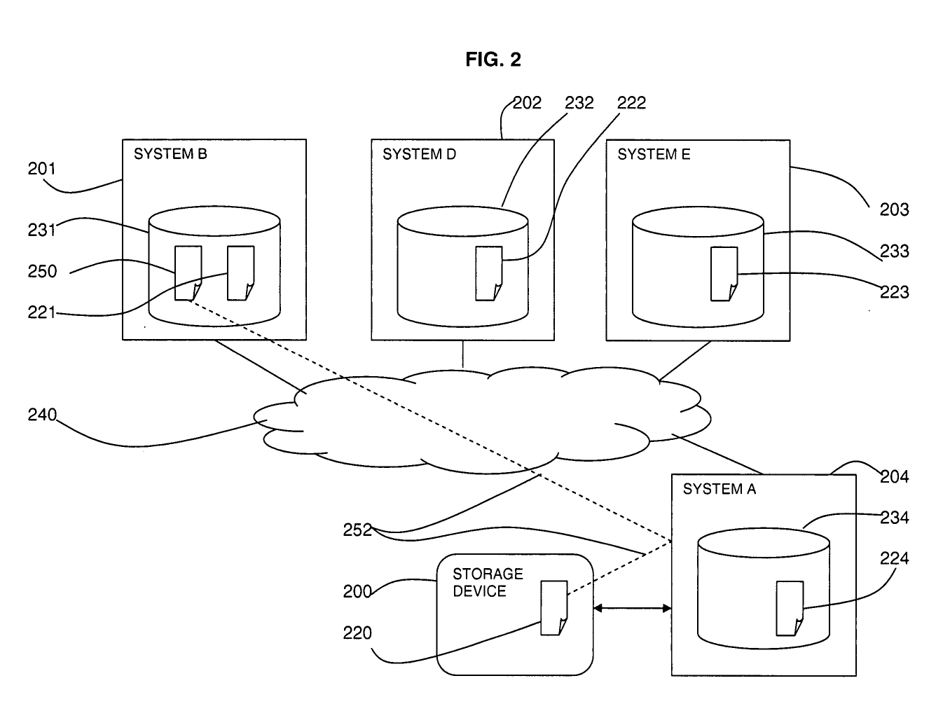

Referring to FIG. 2, an arrangement of distributed computer systems illustrates an example embodiment.

In one embodiment, the client has a storage device 200, for example, in the form of a smart card, a USB key, or other form of readable/writeable portable storage device. The storage device 200 includes a list of locations of entities storing client data and access information 220 to obtain access to the client data at each location.

Entity A has a computer system 204 including a database 234 for storing data records 224. The storage device 200 of the client can be coupled to the computer system 204 to transfer and/or to receive data, notably the access information 220.

In an alternative, the client stores the location and access information 220 on his computer system and provides this to entity A via a network connection using appropriate security procedures to maintain the confidentiality of the location and access information 220.

Entities B, D, E also have computer systems 201-203 each with a database 231-233. The databases 231-234 are shown as part of the computer systems 201-204; however, the databases 231-234 may be separate coupled to the computer system or accessed through a network. More than one entity may share a database, but access to the data records held in the database is via the appropriate entity using the access information.

The computer systems 201-204 of the entities A, B, D and E are all mutually accessible via a network 240.

In another embodiment, the client has a home entity, in this example the home entity is entity B 201. The home entity may be an entity B1 within an umbrella organization B as shown in FIG. 1. The home entity is responsible for maintaining a list 250 of entities which have data records for the client and the access information. The client storage device 200 in this embodiment stores the location and access information for the home entity instead of the location and access information itself.

This list 250 can be updated from the client storage device 200 upon synchronization, or during on-line access while the storage device 200 is coupled to a computer system 204 of another entity. This is shown by a dashed line 252 in FIG. 2.

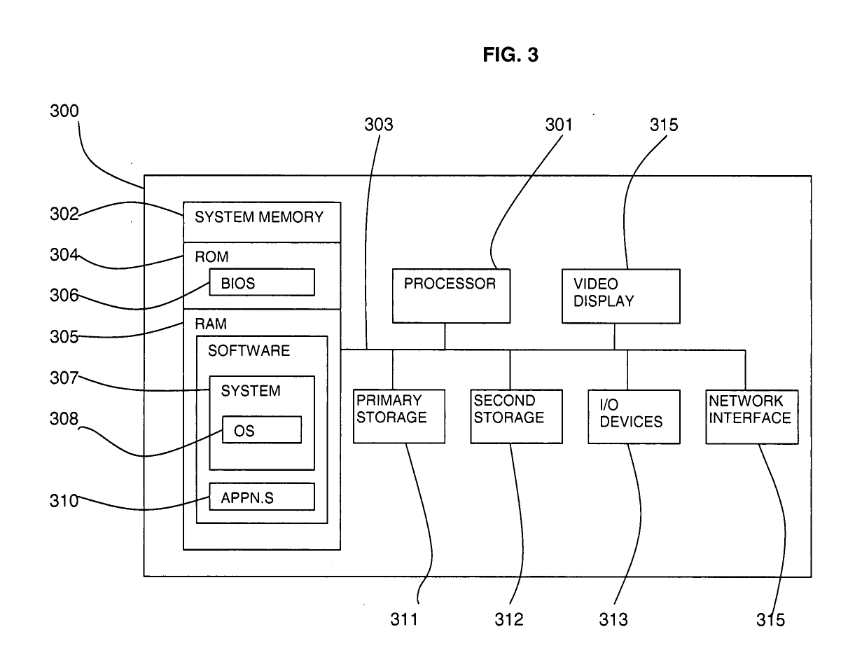

Referring to FIG. 3, an exemplary system for implementing each of the computer systems 201-204 of FIG. 2 is shown. The system 300 is suitable for storing and/or executing program code including at least one processor 301 coupled directly or indirectly to memory elements through a bus system 303. The memory elements can include local memory employed during actual execution of the program code, bulk storage, and cache memories which provide temporary storage of at least some program code in order to reduce the number of times code must be retrieved from bulk storage during execution.

The memory elements may include system memory 302 in the form of read only memory (ROM) 304 and random access memory (RAM) 305. A basic input/output system (BIOS) 306 may be stored in ROM 304. System software 307 may be stored in RAM 305 including operating system software 308. Software applications 310 may also be stored in RAM 305.

The system 300 may also include a primary storage means 311 such as a magnetic hard disk drive and secondary storage means 312 such as a magnetic disc drive and an optical disc drive. The drives and their associated computer-readable media provide non-volatile storage of computer-executable instructions, data structures, program modules and other data for the system 300. Software applications may be stored on the primary and secondary storage means 311, 312 as well as the system memory 302.

The computing system 300 may operate in a networked environment using logical connections to one or more remote computers via a network adapter 316.

Input/output devices 313 can be coupled to the system either directly or through intervening I/O controllers. A user may enter commands and information into the system 300 through input devices such as a keyboard, pointing device, or other input devices. Output devices may include speakers, printers, etc. A display device 314 is also connected to system bus 303 via an interface, such as video adapter 315.

An example application of the proposed method and system is now described in the field of sharing of medical records across geographic locations.

An industry initiative called “Integrating the Healthcare Enterprise (IHE)” specifies a profile of “Cross Enterprise Document Sharing (XDS)”. According to the IHE XDS profile, a set of Care Delivery Organizations (CDOs) are able to share patient medical information by establishing a Clinical Affinity Domain (CAD) and a shared registry that maintain metadata information about availability of patient's documents at any of the CDOs participating at the CAD. The IHE XDS currently does not propose a standard way for CAD registries to communicate. There is currently no standard mechanism for a patient or a care provider to access patient's medical information if stored in multiple registries across several CADs.

Using the described system, patients store the set of registries which maintain their medical information on a storage device, for example, a smart card technology or a USB key. The information on the patient's storage device contains the required information for accessing a given CADs registry. The information on the card does not contain the actual patient medical data. The patient's storage device may store location and access information for the registries and the registries may maintain metadata relating to the availability of the data at the organisations.

The information that may be included for each registry is:

Location information, including registry IP address and port;

Access information, including patient credentials and security attributes. For example, the security attributes may be as used by SAML 2.0 (Security Assurance Markup Language) to allow a XDS consumer to access patient information at the remote registry.

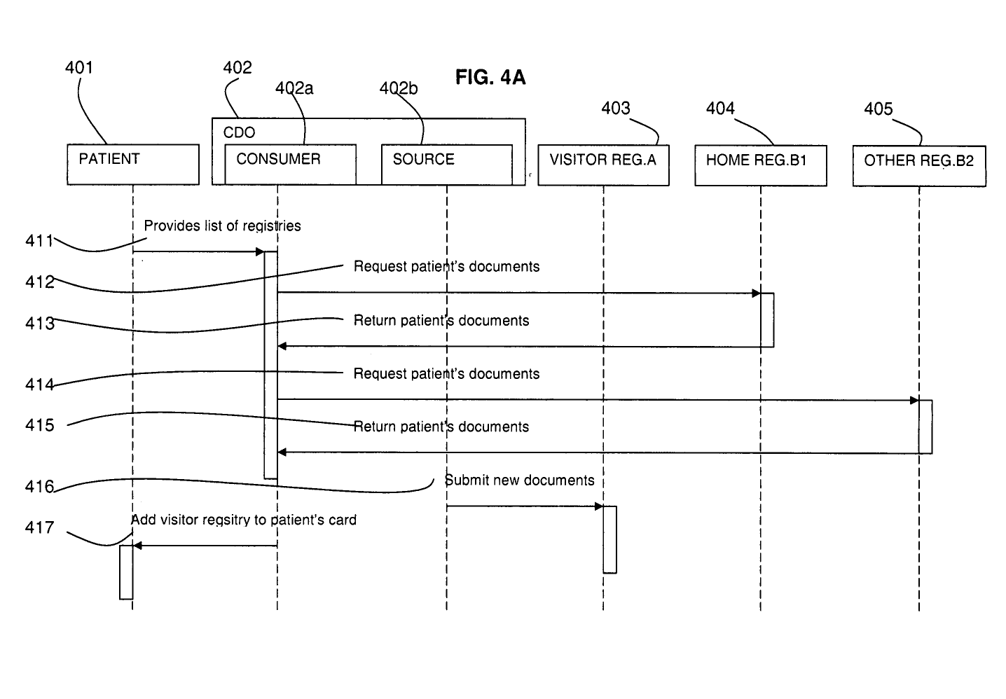

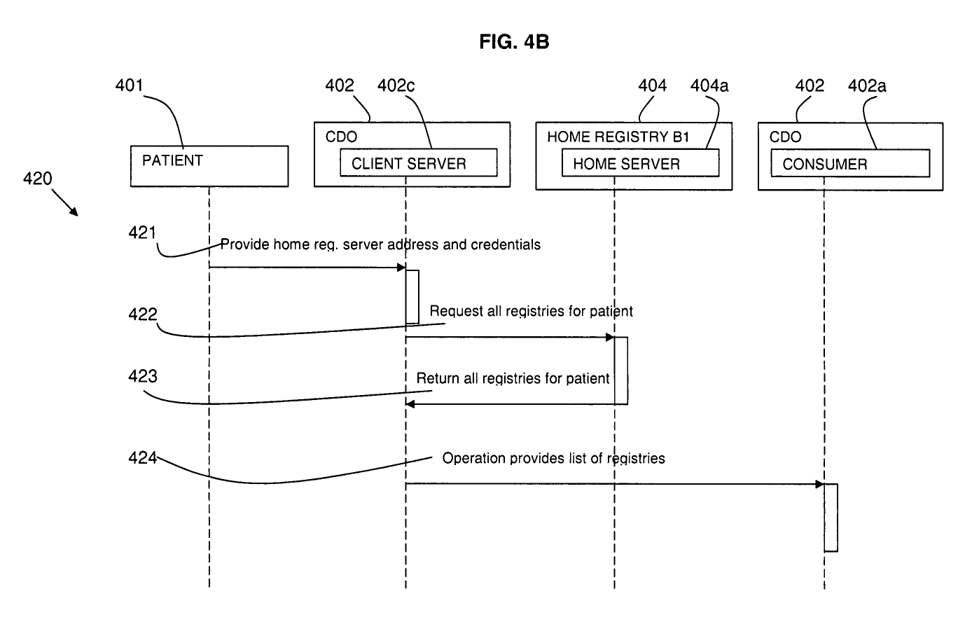

Referring to FIG. 4A, a sequence diagram 400 shows the protocol for a patient 401 who visits a Care Delivery Organisation (CDO) 402 away from his home. The CDO 402 consumes data records 402a and also is the source 402b of new data records for the patient. The CDO 402 has a registry A 403. The patient has a home registry B1 404 and another registry B2 405 which also contains data records relating to the patient.

As a first step 411, the patient provides a list of registries from his smart card to the consumer 402a of the visitor CDO 402. The consumer 402a requests 412 the patient's documents from the patient's home registry B1 404 and these are returned 413 to the consumer 402a. The consumer 402a also requests 414 the patient's documents from the other registry B2 405 which contains data records relating to the patient. These are returned 415 to the consumer 402a.

The CDO 402 being visited by the patient then has all the relevant records relating to the patient. The treatment is then carried out by the CDO 402 and any new documents generated by the source 402b of the CDO 402 are submitted 416 to the registry 403 of the CDO 402. The registry 403 of the visitor CDO 402 is added 417 to the patient's card with the required registry access details.

Referring to FIG. 4B, in the embodiment in which a patient has a home registry which maintains the access records, additional steps are carried out in the process. The home registry B1 404 of a patient is responsible for maintaining the list of visitor registries that have information about the patient and their communication properties (e.g. IP address, port and credential information). This list is updated from the patient smart card upon synchronization, or during on-line access while the patient is receiving treatment at a visitor CDO with falls under a visitor registry and while the visitor registry is accessing the home registry.

FIG. 4B describes the additional protocol 420 that is required for supporting this form of partially centralized document control. The patient's card provides 421 the home registry server 404a address and credentials. The visitor client 402c then retrieves 422 all registry information for the patient from the home registry server 404a and the information is returned 423 to the visitor client 402c. The visitor client 402c then provides 424 the full list of registries to the consumer 402a of the CDO 402: Upon completion of step 424 the control flow continues from step 412 in FIG. 4A.

The described method and system eliminate the need for a centralized discovery service for patient's medical information by providing the patient with a list of registries in which his/her information can be found. The patient maintains the list on any persistent storage device (e.g., a smart card or USB key). Service providers may provide backup and synchronization services for helping the patient to maintain this valuable information.

The main advantage of the solution is that patients have control on their own medical information and no publicly available service is needed to discover the location of their information.

The solution is infinitely scalable because no centralized storage is needed to maintain patient information. Also, an inefficient query over a huge amount of entities (registries) is not required.

This solution is built on a peer to peer communication and therefore increases the adoption chances by allowing registries to collaborate without the need for a global or centralized (international) backbone.

This solution allows the patient full control over privacy, security, and access control.

Another example application of the proposed method and system is in the field of sharing of financial data. Financial data relating or an individual or organization may be required to be accessed by different institutions. For example, a client may wish a different banking organization to access his banking information from his current banking organization. In another example, a client may wish to authorize a financial organization in another country to access his details in his home country.

A further example application of the proposed method and system is in the retail and manufacturing field. Distributed organizations in the form of an original dealer, the manufacturer, repair shops, etc. may all hold information relating to a product bought by a client. In accordance with the described method, the client provides access for another entity to the records held by the distributed organizations. For example, a client may have purchased a television from dealer A who holds details of the purchase, which was manufactured by manufacturer B who holds data relating to the product itself, another manufacturer or spare parts supplier C may hold details of the spare parts needed to repair the television, etc. The client or the product itself, may have a storage device including the location and access information to the data at each of the organizations A, B, C. If the storage device is stored within the product, this information is transferred with the product if the product is passed to another owner. Similarly, this context may be applied to automobiles in which a vehicle is repaired in a garage remote from its usual servicing garage, or a vehicle rental service in which records relating to a vehicle are required at distributed locations.

A further example application is in the field of cellular telephony in which a client's telephone details are held by distributed organizations.

Another field of application is education records relating to a student which may be generated by different schools, colleges, and other teaching organizations over a student's career. The student may hold the location and access information which can be supplied to another entity, for example a prospective employer, to verify the student's qualifications.

Another field of application in which access to confidential information may be required is that of police, court and prison records. Lists of past offenses of an individual are very sensitive material and are only supplied to authorized personnel. Therefore, a client would hold the location and access information.

A further field of application is insurance records where a client may have various insurance policies with distributed organizations and a client may wish to hold the location and access information which can be supplied to another entity as required.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method for access to distributed data, comprising:
storing client data with a first entity, the first entity requiring access information to access the client data;
a client providing the access information to a second entity; and
the second entity accessing the stored client data from the first entity.

2. A method as claimed in claim 1, wherein the method includes storing data for a single client with a plurality of first entities.

3. A method as claimed in claim 1, wherein the client provides the access information in the form of location and access information for each first entity.

4. A method as claimed in claim 1, wherein the client provides the access information by providing location and access information to a register of the first entities and their access information.

5. A method as claimed in claim 4, wherein the register is updated by synchronising with the client or during on-line access by a second entity.

6. A method as claimed in claim 1, wherein the access information is credential and authorisation information specific to the client.

7. A method as claimed in claim 3, wherein the location information is an Internet Protocol address or a Uniform Resource Locator.

8. A method as claimed in claim 1, wherein the first entity stores the client data in a database accessed via the first entity.

9. A method as claimed in claim 1, wherein new client data generated by a second entity is stored by the second entity, the second entity requiring access information to access the new client data.

10. A method as claimed in claim 3, wherein the access information is held by the client or a reference to the access information is held by the client.

11. A system for access to distributed data, comprising:
a first entity storing client data, the first entity requiring access information to access the client data;
a storage device held by the client providing the access information; and
a second entity capable of accessing the stored client data from the first entity when provided with the access information from the client.

12. A system as claimed in claim 11, wherein a plurality of first entities store client data for a single client.

13. A system as claimed in claim 11, wherein the storage device provides the access information in the form of location and access information for each first entity.

14. A system as claimed in claim 11, wherein the storage device provides the access information by providing location and access information to a register of the first entities and their access information.

15. A system as claimed in claim 14, wherein the register is updated by synchronising with the client storage device or during on-line access by a second entity.

16. A system as claimed in claim 11, wherein the storage device is portable storage device which, in use, is coupled to a second entity.

17. A system as claimed in claim 11, wherein the storage device is provided on a client's computer system and access information is provided to a second entity via a network communication.

18. A system as claimed in claim 13, wherein the location information is an Internet Protocol address and the second entity accesses the client data from the first entity via a network.

19. A system as claimed in claim 11, wherein new client data generated by the second entity is stored by the second entity, the second entity requiring access information to access the client data.

20. A computer program product stored on a computer readable storage medium for access to distributed data, comprising computer readable program code means for performing the steps of:
storing client data with a first entity, the first entity requiring access information to access the client data;
a client providing the access information to a second entity; and
the second entity accessing the stored client data from the first entity.
